(19) United States
(12) Patent Application Publication
(10) Pub. No.: US 2026/0038058 A1
(43) Pub. Date: Feb. 5, 2026

(54) INFORMATION PROCESSING SYSTEM, INFORMATION PROCESSING METHOD, AND COMPUTER - READABLE MEDIUM

(71) Applicant: NEC Corporation, Tokyo (JP)

(72) Inventors: Toshihiko HIROAKI, Tokyo (JP); Narihito Kikuchi, Tokyo (JP)

(73) Assignee: NEC Corporation, Tokyo (JP)

(21) Appl. No.: 19/271,017

(22) Filed: Jul. 16, 2025

(30) Foreign Application Priority Data
Jul. 31, 2024 (JP) 2024-124239

(51) Int. Cl. G06Q 40/08

(52) U.S. Cl. CPC G06Q 40/08223; G06Q 40/085

(57) ABSTRACT

An information processing system according to an aspect includes one or more memories that store an instruction and one or more processors that execute the instruction. The one or more processors acquires risk information of a disaster related to a place where a management target managed by an administrator is present, selects one or more countermeasures for suppressing damage caused by the disaster based on the risk information, calculates a profit of the administrator which is generated in a case where at least one of the one or more countermeasures is executed, and outputs the one or more countermeasures and the profit.

### INCORPORATION BY REFERENCE

This application is based upon and claims the benefit of priority from Japanese patent application No. 2024-124239, filed on Jul. 31, 2024, the disclosure of which is incorporated herein in its entirety by reference.

### TECHNICAL FIELD

The present disclosure relates to an information processing system, an information processing method, and a program.

### BACKGROUND ART

In modern times, it is essential to take countermeasures against disasters such as earthquakes and flood damages. Particularly, in recent years, it is considered that the risk of disaster is higher than before as climate change progresses. Therefore, a technique for evaluating a disaster risk has been developed.

For example, JP 2004-280444 A discloses an evaluation system that evaluates a difference between a direct loss amount at the time of disaster in a current facility and a direct loss amount at the time of disaster in a facility after a countermeasure, and compares the difference with a facility cost for disaster countermeasures.

### SUMMARY

In the evaluation system according to JP 2004-280444 A, there is a possibility that it is unclear for the user what kind of disaster countermeasure is executed.

An example object to be achieved by an example embodiment of the present disclosure is to provide an information processing system, an information processing method, and a program capable of assisting a user to determine countermeasures against a disaster. The object is merely one example of a plurality of objects to be achieved by a plurality of example embodiments disclosed herein. The other objects or problems and novel features will be apparent from the description of the present specification or the accompanying drawings.

In a first example aspect of the present disclosure, an information processing system includes:
one or more memories that store instructions; and
one or more processors that execute the instructions,
in which the one or more processors execute the instructions to perform:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.

In a second example aspect of the present disclosure, an information processing method executed by a computer includes:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.

In a third example aspect of the present disclosure, a program causing a computer to execute:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.

An example of effects of the present disclosure is to provide an information processing system, an information processing method, and a program capable of assisting a user to determine countermeasures against a disaster.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of configuration of an information processing system according to the present disclosure;

FIG. 2 is a flowchart illustrating an example of representative processing in the information processing system;

FIG. 3 is a block diagram illustrating an example of a product generation system according to the present disclosure;

FIG. 4 is a diagram illustrating a relationship between parties in a generated financial product;

FIG. 5 is a flowchart illustrating an example of financial product generation processing of the product generation system;

FIG. 6 is a flowchart illustrating an example of payment determination processing of the product generation system;

FIG. 7 is a block diagram illustrating an example of a product generation system according to the present disclosure;

FIG. 8 is a block diagram illustrating an example of an insurance support system according to the present disclosure;

FIG. 9 is a diagram illustrating a relationship between parties in insurance;

FIG. 10 is a flowchart illustrating an example of countermeasure determination processing of the insurance support system;

FIG. 11 is a block diagram illustrating an example of the insurance support system according to the present disclosure; and

FIG. 12 is a block diagram illustrating a hardware configuration example of an information processing apparatus in which processing of a system is executed.

### EXAMPLE EMBODIMENT

Hereinafter, an example embodiment of the present disclosure will be described with reference to the drawings. Note that the following description and drawings in the example embodiment are omitted and simplified as appropriate for clarity of description. Further, in the present disclosure, unless otherwise specified, in a case where “at least one of a plurality of items” is defined for a plurality of items, the definition may mean any one item or may mean any two or more items including all items.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### [Description of Configuration]

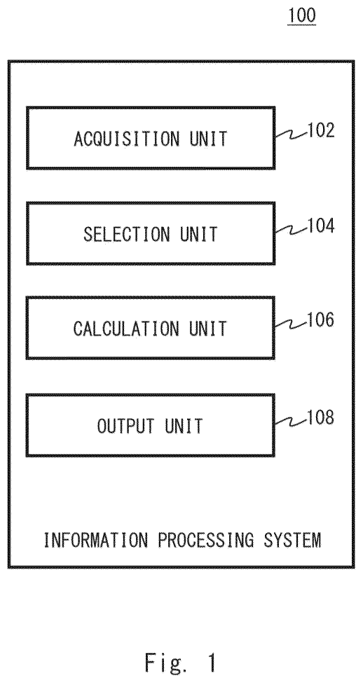

FIG. 1 is a block diagram illustrating an example of configuration of an information processing system according to the present disclosure. An information processing system 100 includes an acquisition unit 102, a selection unit 104, a calculation unit 106, and an output unit 108. Each unit will be described below.

The acquisition unit 102 acquires risk information of a disaster related to a place where a management target managed by an administrator is present. The administrator may be an individual, or may be a corporation such as a business operator, an insurance company, or a local government. The administrator may own or occupy the object to be managed, or may have some kind of restricted property rights (for example, superficies or pledges) related to the object to be managed. The management target may be a target of some kind of contract such as insurance, or may belong to a region administratively controlled by the administrator. The management target may be, for example, one or a plurality of tangible objects or a certain region. The tangible object may include, for example, at least one of the following.

Movable properties such as vehicles, machines, furniture, daily necessities, art works, documents, banknotes, and securities
Private buildings such as houses and commercial facilities
Public buildings such as schools, hospitals, and government offices
Structures such as roads, bridges, dams, water gates, and banks
Living infrastructure such as traffic, electricity, gas, water supply, and communication
People, animals to be traded such as livestock, and plants to be traded such as crops
Natural environment to be maintained, such as forests

Public buildings, structures, and infrastructure for living are also collectively referred to as infrastructure. In a case where the management target is a predetermined region, it is assumed that a large number of infrastructures are included in the region.

The risk information of a disaster related to the place where the object to be managed is present is, for example, information indicating the possibility of a disaster occurring in a region where the building or the infrastructure to be managed is present and the scale of the disaster. As the disaster, for example, an earthquake, a tsunami, a flood damage (for example, a flood, a heavy rain, a high tide, or the like), a heavy snow, a tornado, a sediment disaster, a fire, and the like are assumed, but the disaster is not limited thereto.

The selection unit 104 selects one or more countermeasures for suppressing damage caused by a disaster relating to the risk information based on the risk information acquired by the acquisition unit 102. The countermeasures may be different depending on the disaster. For example, if there is a risk of flood damage caused by a typhoon, evacuation of vehicles, stacking of soil around buildings, closing of water gates and roads, and the like can be cited as short-term countermeasures against the management target in order to prevent damage. In addition, as a short-term countermeasure for saving human life, there are issuing an alarm for urging evacuation action, installing evacuation shelters, and the like. Examples of the long-term countermeasure for the object to be managed include construction, demolition, inspection, or repair work of a building or an infrastructure, and development of a disaster prevention information system or a business continuity plan. The short-term countermeasure is, for example, a countermeasure taken on an hourly or daily basis, and the long-term countermeasure is, for example, a countermeasure taken on a monthly or yearly basis.

The selection unit 104 may select one or more countermeasures from among the candidates of countermeasures stored in the information processing system 100, or may select one or more countermeasures from among the candidates of countermeasures acquired from the outside of the information processing system 100. Alternatively, the selection unit 104 may select one or more countermeasures by generating information on the countermeasure.

The calculation unit 106 calculates the profit of the administrator which is generated in a case where at least one of the selected one or more countermeasures (hereinafter, also referred to as a selected countermeasure) is executed. The profit of the administrator is calculated, for example, using the following calculation formula.

$$P = A - B \qquad ( 1 )$$

Here, P is the profit, A is the loss incurred by the administrator due to the disaster in a case where the selected countermeasure is not executed, and B is the loss incurred by the administrator due to the disaster in a case where the selected countermeasure is executed. The loss A and the loss B are expressed as positive values.

The calculation unit 106 may calculate the net profit of the administrator which is generated in a case where at least one of the selected countermeasures is executed instead of the profit P or in addition to the profit P. The net profit Q is calculated, for example, using the following calculation formula.

$$Q = A - ( B + C ) \qquad ( 2 )$$

C is a burden (that is, a loss) on the administrator caused by execution of the selected countermeasure, and is expressed as a positive value. The profit P, the net profit Q, the loss A, the loss B, and the burden C described above are represented in an arbitrary unit that can be converted into a monetary value.

The loss includes at least one of damage directly or indirectly caused to buildings, infrastructures, or natural environments by a disaster. The directly caused damage indicates damage (for example, the cost for repairing destruction or breakage, and the cost for removing rubble) physically caused by a disaster to buildings and infrastructures. On the other hand, examples of the indirectly caused damage include a loss that is not a physical loss due to a disaster, such as blocking of a transportation network, stopping of a supply chain, lowering of an asset value of a tangible object, and lowering of a regional economic activity. Hereinafter, an example of each item of (1) or (2) in a case where flood damage is assumed as a disaster risk will be described.

(i) It is assumed that the administrator is an insurance company and the management target is a vehicle that is a target of an insurance contract. The selected countermeasure is to move the vehicle from a place where flood damage occurs to a safe place where flood damage does not occur. In this case, the loss A is an insurance money that the insurance company pays to the owner in a case where the owner's vehicle gets stuck in water and breaks down. The insurance money is, for example, repair money or replacement money. On the other hand, the loss B is an insurance money that the insurance company pays to the owner for the loss generated in a case where the vehicle is moved based on the selected countermeasure and then flood damage occurs, and is, for example, 0. The burden C is a burden generated on the insurance company in a case where the vehicle is moved. For example, a reward paid to the owner by the insurance company for moving the vehicle is relevant to the reward.

(ii) It is assumed that the administrator is an insurance company and the management target is a building covered by an insurance contract. The selected countermeasure is to accumulate soil around the building. In this case, the loss A is an insurance money that the insurance company pays to the owner in a case where the owner's building is submerged. On the other hand, the loss B is an insurance money paid to the owner by the insurance company for the loss generated in a case where the selected countermeasure is executed and flood damage occurs. The burden C is a burden imposed on the insurance company in a case where the owner accumulates soil. For example, a reward paid to the owner by the insurance company for piling soil is relevant to the reward.

The reward indicated in (i) and (ii) is an example of an incentive described later, and is paid in a case where the insurance company confirms that the owner has executed the selected countermeasure. The amount of the reward can be changed as appropriate.

(iii) It is assumed that the administrator is the owner of the vehicle and the management target is the vehicle. The presence of vehicle insurance is not considered. In this case, the loss A is a repair money or a replacement money paid by the owner in a case where the vehicle gets stuck in water and fails. On the other hand, the loss B is a loss caused by flood damage in a case where the vehicle is moved based on the selected countermeasure, and is, for example, 0. The burden C is a burden generated on the owner in a case where the vehicle is moved, and is relevant to, for example, a fuel cost and a parking fee for the movement.

(iv) It is assumed that the administrator is a local government and the management target is a region managed by the local government. Here, as a short-term selected countermeasure, it is assumed that the water gate is closed, evacuation shelters are installed, and evacuation instructions are issued. In this case, the loss A is an expenditure (for example, the rescue cost, the restoration cost, and the support money to be paid to the local residents) of the local government which is generated in a case where physical and personal damages occur due to flood damage in a state where the selected countermeasure is not executed. On the other hand, the loss B is an expenditure of the local government which is generated in a case where physical and personal damages occur due to flood damage in a state where the selected countermeasure is executed. The burden C is a burden on the local government in a case the water gate is closed and an evacuation shelter is installed.

(v) It is assumed that the administrator is a local government and the management target is a region managed by the local government. Here, as a long-term selected countermeasure, a flood control work (infrastructure development) such as construction of banks and water gates is assumed. In this case, the loss A is an expenditure of the local government which is generated in a case where physical and personal damages occur due to flood damage in a state where the selected countermeasure is not executed. On the other hand, the loss B is an expenditure of the local government which is generated in a case where physical and personal damages occur due to flood damage in a state where the selected countermeasure is executed. The burden C is a burden on the local government at the time of the flood control work.

(vi) It is assumed that the administrator is the owner of the building and the management target is the building. As a long-term selected countermeasure, a flood control work such as construction of banks and water gates is assumed. As the selected countermeasure, construction for disaster prevention purposes such as flood control work such as maintenance of drainage facilities such as sewer systems, installation of windproof forests, reinforcement of embankment construction and embankment, and ground improvement for landslides and liquefaction may be assumed. Here, it is assumed that the flood control works are borne by private business operators. In this case, the loss A is an expenditure of the local government which is generated in a case where physical and personal damages occur due to flood damage in a state where the selected countermeasure is not executed. On the other hand, the loss B is an expenditure of the local government which is generated in a case where physical and personal damages occur due to flood damage in a state where the selected countermeasure is executed. In a case recovery and restoration from physical damage caused by disaster are performed, new carbon dioxide emissions associated with construction and the like are assumed. The loss A and the loss B may include the cost of the offset related to the assumed carbon dioxide emission. The burden C is a burden paid by the owner at the time of the flood control work.

In any case, in a case where the loss A is compared with the loss B, the loss B can be expected to be considerably lower than the loss A because the execution or non-execution of the selected countermeasure is different. Therefore, even in consideration of the presence of the burden C, it is considered that a positive net profit Q occurs.

Before the selection unit 104 selects one or more countermeasures, the calculation unit 106 may calculate at least one of the profit P or the net profit Q of the administrator that would be generated if each candidate for a countermeasure to be selected by the selection unit 104 has been executed. That is, either the selection unit 104 or the calculation unit 106 may be executed first.

The output unit 108 outputs, as output information, at least one of the one or more countermeasures selected by the selection unit 104 or the profit P or the net profit Q calculated by the calculation unit 106 for the one or more countermeasures. The output unit 108 may further include the loss A (disadvantage) generated in a case where the countermeasure is not executed in the output information. The output unit 108 may output the output information to another processing unit in the information processing system 100. Alternatively, the output unit 108 may notify the user of the output information using visual display, printout, audio, or the like. The output may be performed for the administrator or may be performed for a target (for example, insurance contractors and investors in financial products) other than the administrator.

### [Description of Flow]

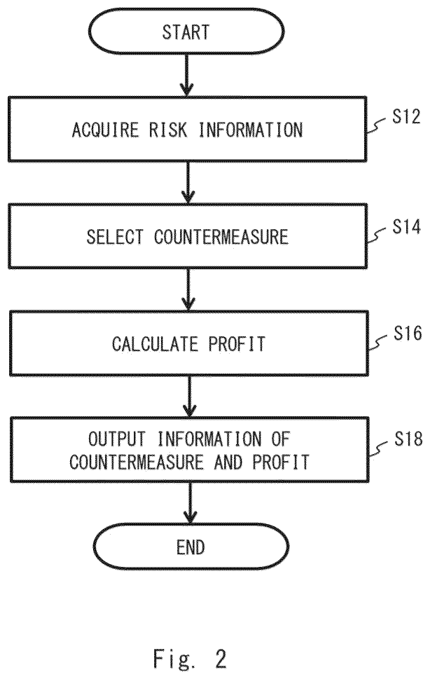

FIG. 2 is a flowchart illustrating an example of representative processing of the information processing system 100. With this flowchart, processing of the information processing system 100 will be described. Since details of each processing are as described above, description thereof is omitted as appropriate.

The acquisition unit 102 acquires risk information of a disaster related to a place where a management target is present (step S12). The selection unit 104 selects one or more countermeasures for suppressing damage caused by a disaster based on the risk information acquired in step S12 (step S14). The calculation unit 106 calculates a profit (profit P or net profit Q) of the administrator which is generated in a case where at least one of the selected one or more countermeasures is executed (step S16). The output unit 108 outputs one or more countermeasures and a profit (step S18). Either the processing in step S14 or the processing in step S16 may be executed first, or both processing may be executed in parallel.

### [Description of Effects]

As described above, the information processing system 100 outputs one or more countermeasures and at least one of the profit P or the net profit Q relevant thereto. The user can determine whether to execute the countermeasure or which countermeasure is executed based on the output information based on the profit. Therefore, the information processing system 100 can support the user to determine countermeasures against a disaster.

The information processing system 100 may further output information of the loss A. As a result, the information processing system 100 can urge the user to execute the countermeasure by presenting a loss in a case where the countermeasure is not executed to the user.

The information processing system 100 may be configured as a single computer device or may be configured as a distributed system including a plurality of computer devices. In the distributed system, processing executed by the information processing system 100 can be shared and executed by a plurality of computer devices. That is, the information processing system 100 may be implemented in such a manner that the acquisition unit 102 to the output unit 108 are distributed and mounted on two or more computer devices, and the two or more computer devices can communicate with each other.

Some or all of the units of the information processing system 100 may be provided in a cloud server constructed on a cloud, or may be provided in another type of virtualization server generated using virtualization technology or the like. Functions other than the functions provided in the server such as a cloud server or a virtualization server are provided in an edge device.

In the following example embodiments, specific examples of the information processing system 100 described in the first example embodiment are disclosed. Note, however, that specific examples of the information processing system 100 illustrated in the first example embodiment are not limited to those described below. Configurations and processing described below are examples, and the present disclosure is not limited thereto.

### Second Example Embodiment

### (2A)

### [Description of Configuration]

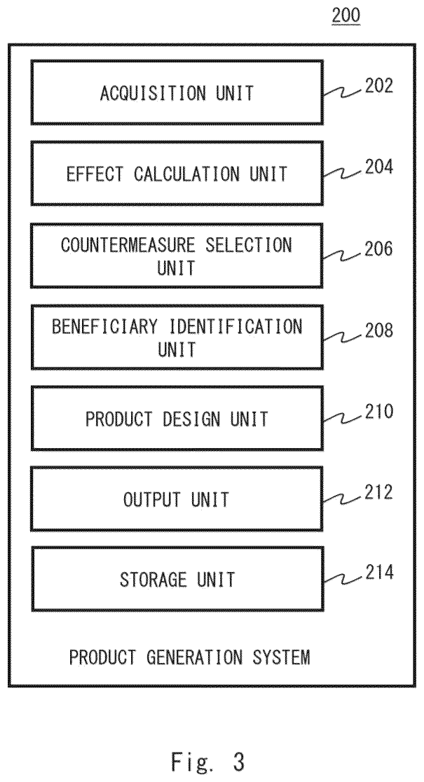

FIG. 3 is a block diagram illustrating an example of a product generation system according to the present disclosure. A product generation system 200 includes an acquisition unit 202, an effect calculation unit 204, a countermeasure selection unit 206, a beneficiary identification unit 208, a product design unit 210, an output unit 212, and a storage unit 214. The product generation system 200 is, for example, a system managed by a business operator (for example, a securities company or a fund) that provides a financial product.

The acquisition unit 202 acquires risk information of a disaster related to a target region of a financial product and information (hereinafter, also described as countermeasure information) on a plurality of countermeasures for suppressing damage caused in the target region by the disaster. The risk information and the countermeasure information may be stored in the storage unit 214 or may be acquired by the acquisition unit 202 from the outside of the product generation system 200. Alternatively, as shown in (2B), the product generation system 200 may generate the risk information and the countermeasure information.

The risk information indicates a risk of disaster occurring in the target region from a long-term viewpoint. The risk information includes, for example, a period (for example, several years to several tens of years) subject to risk, an occurrence probability of a disaster within the period, and information on a scale of an assumed disaster and details of damage. Details of the damage indicate losses of physical and personal damage estimated to be caused by the disaster. The loss is expressed as, for example, a damage amount.

The countermeasure information includes a countermeasure action planned for suppressing damage caused by a disaster as a countermeasure. Here, the countermeasure is a long-term countermeasure, and examples thereof include construction, demolition, inspection, or repair work of a building or an infrastructure, a disaster prevention information system, and preparation of a business continuity plan, as described above. Here, it is assumed that there are a plurality of proposed countermeasures. The countermeasure information also includes information regarding the scale of the assumed disaster and details of the damage in a case where each countermeasure is executed. The information regarding the details of the damage is as described above, and the loss is represented as, for example, a damage amount. Furthermore, the countermeasure information also includes information on the cost and period required for completing each proposed countermeasure.

As the risk information and the countermeasure information, information simulated by a computer based on weather data and geographic data of a region is generated. The risk information and the countermeasure information are indicated as, for example, a hazard map.

In a case where the scale of the assumed disaster is the same, it is considered that the loss indicated in the countermeasure information is smaller than the loss indicated in the risk information. This is because it is assumed that the damage caused by the disaster is suppressed by the countermeasure indicated in the countermeasure information.

Using the risk information and the countermeasure information, the effect calculation unit 204 calculates, for each countermeasure, a loss amount that is considered to be reduced by the countermeasure indicated in the countermeasure information. The risk information includes information on the loss A, and the countermeasure information includes information on the loss B and the burden C. The effect calculation unit 204 calculates at least one of the profit P or the net profit Q as a loss amount that is considered to be reduced by the countermeasure. The effect calculation unit 204 outputs the calculation result to the countermeasure selection unit 206.

The type of disaster assumed in the risk information to be compared is the same as the type of disaster assumed in the countermeasure information. In a case where the scale of the disaster assumed in the risk information is the same as the scale of the disaster assumed in the countermeasure information, the effect calculation unit 204 can use the information on the details of the damage in the risk information and the information on the details of the damage in the countermeasure information as they are as the information on the loss A and the information on the loss B. In a case where the scale of the disaster assumed in the risk information is different from the scale of the disaster assumed in the countermeasure information, the effect calculation unit 204 changes at least one of the scales so as to integrate both the scales into the same scale. Then, in response to the change in the scale of the disaster, the effect calculation unit 204 changes the information on the details of the damage relevant to the information on the changed scale of the disaster. After the change, the effect calculation unit 204 uses the information regarding the details of the damage in the risk information and the information regarding the details of the damage in the countermeasure information as the information of the loss A and the information of the loss B.

The effect calculation unit 204 may calculate the profit P or the net profit Q by further using at least one of a period subject to risk included in the risk information, an occurrence probability of a disaster, or a period required for a countermeasure included in the countermeasure information to be completed (hereinafter, also described as completion period).

For example, it is assumed that a period required for completing the infrastructure construction as a countermeasure is five years, and an occurrence probability of a disaster in the period (that is, within five years) is a predetermined value or more (for example, 50% or more). In this case, the effect calculation unit 204 determines that a disaster is highly likely to occur until the completion of the infrastructure construction. The effect calculation unit 204 evaluates the loss B used in the calculation of (1) or (2) higher than the loss B in a case where a disaster occurs after completion of infrastructure construction. For example, the effect calculation unit 204 may evaluate the loss B used in the calculation of (1) or (2) as the same amount of money as the loss A. The effect calculation unit 204 evaluates the burden C used in the calculation of (2) to be lower than the burden C required until the completion of the infrastructure construction.

On the other hand, in a case where the period required until the completion of the infrastructure construction as a countermeasure is five years and the occurrence probability of a disaster within five years is less than a predetermined value, the effect calculation unit 204 evaluates the loss B used in the calculation of (1) or (2) as the loss B in a case where a disaster occurs after the completion of the infrastructure construction. The effect calculation unit 204 evaluates the burden C used in (2) as a burden C to be applied until the completion of the infrastructure construction.

The countermeasure selection unit 206 selects one or more countermeasures for suppressing damage caused by a disaster based on the calculation result of the effect calculation unit 204. For example, the countermeasure selection unit 206 selects (hereinafter, also referred to as primary selection) one in which the profit P or the net profit Q has a positive value from among the plurality of countermeasures. Then, the countermeasure selection unit 206 further selects (hereinafter, also referred to as secondary selection) one or a plurality of countermeasures from among the selected countermeasures.

For example, in the secondary selection, the countermeasure selection unit 206 selects one countermeasure from a plurality of countermeasures selected in the primary selection. Here, only one of the plurality of countermeasures can be executed based on a physical or budget constraint condition. The physical or budget constraint condition may be set in the form of, for example, a contract between an administrator and a business operator providing a financial product. The countermeasure selection unit 206 can select one countermeasure from a plurality of countermeasures based on the contract information.

Here, the countermeasure selection unit 206 may select one countermeasure based on at least one of the profit P, the net profit Q, the burden C, or the completion period of the countermeasure. For example, the countermeasure selection unit 206 may select any one of the profit P, the net profit Q, the value obtained by dividing the profit P or the net profit Q by the burden C being the maximum, the burden C, and the completion period being the minimum. Alternatively, the countermeasure selection unit 206 may set a function using two or more parameters of the profit P, the net profit Q, the burden C, and the completion period, and select a countermeasure having the maximum or minimum value calculated using the function for each countermeasure.

The countermeasure selection unit 206 determines the one countermeasure selected by the secondary selection as described above as a countermeasure for a financial product (hereinafter, also referred to as target countermeasure). However, the countermeasure selection unit 206 may include two or more countermeasures that can be executed in parallel in the target countermeasure. Here, the countermeasure selection unit 206 may impose a constraint condition such that at least one of a total burden amount obtained by summing the burden C of a plurality of countermeasures for a financial product or a period during which all of the plurality of countermeasures are completed is equal to or less than a predetermined value. Instead of this constraint condition or in addition to this constraint condition, the countermeasure selection unit 206 may impose a constraint condition such that a total profit amount obtained by adding the profits P (or the net profit Q) of a plurality of countermeasures to be a target of a financial product is equal to or more than a predetermined value.

The countermeasure selection unit 206 may determine the constraint condition regarding the budget described above based on, for example, at least one of a budget of a local government that has jurisdiction over the target region or a budget of a financial product to be generated. The countermeasure selection unit 206 outputs information on the target countermeasure determined as described above to the beneficiary identification unit 208 and the product design unit 210.

The beneficiary identification unit 208 identifies a beneficiary who receives a profit in a case where the target countermeasure is executed. For example, the beneficiary identification unit 208 compares the hazard map indicated by the risk information with the hazard map related to the target countermeasure indicated by the countermeasure information. Through this comparison, the beneficiary identification unit 208 identifies at least one of the resident or the business operator whose damage suffered is reduced. Alternatively, the beneficiary identification unit 208 may identify one or more local governments that have jurisdiction over a target region in which the damage suffered is reduced in a case where the target countermeasure is executed. That is, the beneficiary identified by the beneficiary identification unit 208 may be an entity (that is, a local government) that executes the target countermeasure or may be different from the entity that executes the target countermeasure. Furthermore, the beneficiary identification unit 208 may calculate the amount of profit in a case where the target countermeasure is executed for each beneficiary by comparing the hazard maps.

The beneficiary identification unit 208 outputs, to the product design unit 210, identification information that is information for identifying the identified beneficiary, and detailed information necessary in a case where a financial product is generated with the beneficiary as a contract target. The detailed information may include the amount of profit for each beneficiary in a case where the target countermeasure is executed.

The product design unit 210 generates a financial product based on the information on the target countermeasure. For example, the product design unit 210 determines a parameter indicating a characteristic of a financial product based on risk information (for example, the occurrence probability of a disaster within a predetermined period of time), or at least one of a total burden amount of target countermeasures, a period in which all countermeasures are completed, or a total profit amount. In this manner, the product design unit 210 generates a financial product. The product design unit 210 outputs the generated information on the financial product to the output unit 212.

The parameter to be determined is, for example, at least one of a redemption period, a redemption date, a payment amount of a beneficiary, a target total amount of assets, an amount per unit of a financial product (for example, a base value), a distribution (or yield), or a term premium, but an example of the parameter is not limited thereto. The payment amount of the beneficiary is the total profit amount or an amount obtained by subtracting a predetermined margin from the total profit amount and allocating the amount to each beneficiary.

The product design unit 210 may determine the parameter using not only the information described above but also the identification information and the detailed information output by the beneficiary identification unit 208. The product design unit 210 may further determine the parameter indicating the characteristic of the financial product by further using at least one of information of a contract term between the administrator and a business operator providing the financial product, a law (for example, the financial product transaction law), or a condition requested by the investor. Specific examples of the generated financial product include, but are not limited to, an investment trust and a bond. The bond is, for example, a CAT (Catastrophe) bond.

The output unit 212 outputs information on the financial product generated by the product design unit 210. The output unit 212 may output the information on the financial product to at least one terminal of the beneficiary, the local government that executes the target countermeasure, or the investor.

The output unit 212 may present detailed information in addition to the information of the financial product to the beneficiary or the like. As a result, the beneficiary or the like can grasp how much profit can be obtained in a case where the financial product is sold and the target countermeasure is executed. The output unit 212 may further include the loss A (disadvantage) used in the calculation of (1) or (2) in the detailed information.

The beneficiary, the investor, or the like may request update of the determined parameter or the contract term necessary for generating the financial product based on the presented detailed information. The product design unit 210 updates the parameters of the financial product to be generated based on the updated information. That is, the product design unit 210 updates the generated financial product. The output unit 212 outputs the updated information on the financial product again. This flow is continued until the beneficiary, the investor, or the like no longer requests updating of the financial product.

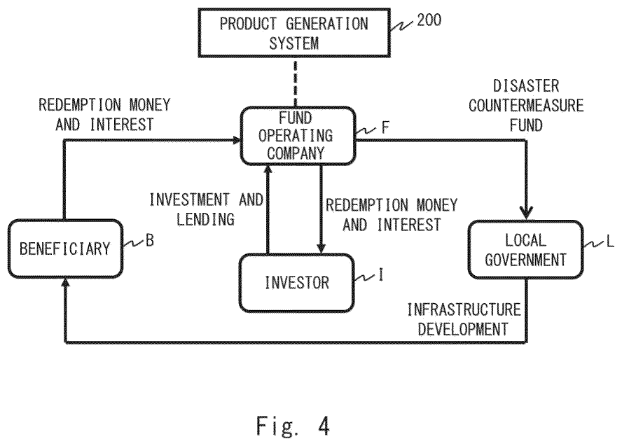

FIG. 4 is a diagram illustrating relationships between parties in the generated financial product. A fund operating company F (hereinafter, also referred to as an operating company F), which is an operating mechanism of the fund, receives payment of the amounts of the redemption money and the interest from a beneficiary B. The description of the payment amount of the beneficiary is as described above. The operating company F receives an investment or a loan from an investor I. The operating company F transfers all or a part of the amount received from the beneficiary B and the investor I to a local government L that executes the target countermeasure as the disaster countermeasure fund. The local government L executes infrastructure development indicated in the target countermeasure using the disaster countermeasure fund. As a result, in the event of a disaster, the beneficiary receives profit.

In a case where a disaster occurs, the product design unit 210 compares the condition of the occurrence of the disaster with the contract terms of the financial product. For example, the product design unit 210 determines whether the time and scale at which the disaster actually occurred match the conditions described in the contract terms.

In a case where the time and scale of actual occurrence of a disaster match the conditions described in the contract terms, the effect calculation unit 204 estimates the damage amount in a case where a disaster under the same conditions occurs in a case where infrastructure development is not being executed. This estimation may be performed using the risk information described above. The effect calculation unit 204 calculates an amount obtained by subtracting the current damage amount (that is, the damage amount in a state in which the infrastructure development is executed) from the estimated damage amount. The calculated amount of money indicates the degree of decrease in the damage amount caused by execution of the infrastructure development, and is an amount of money that can be actually regarded as the profit of the beneficiary. Whether the infrastructure development indicated in the target countermeasure is actually executed is determined by monitoring of the operating company F or the like.

The product design unit 210 calculates, as the difference, an amount obtained by subtracting the total profit amount determined at the time that the financial product is generated from the amount calculated by the effect calculation unit 204. Then, the product design unit 210 adjusts the parameters of the financial product based on the calculated difference. The parameter to be adjusted is, for example, a redemption period, a redemption date, a distribution (or yield), and a term premium, but is not limited thereto. For example, the product design unit 210 may define the yield of the financial product so as to have a relationship between the calculated difference and a monotonic increase. The product design unit 210 determines redemption money and interest to be paid to the investor I based on the adjusted parameters. The operating company F pays the determined redemption money and interest to the investor I, as shown in FIG. 4. The interest to be paid to investor I may be increased or decreased based on the above comparison between the conditions for occurrence of a disaster and the contract terms of the contract of the financial product.

For at least one of the effect calculation unit 204, the countermeasure selection unit 206, the beneficiary identification unit 208, or the product design unit 210, for example, the above-described processing may be executed using a learned model stored in the storage unit 214. The model is a model learned by a machine learning method. For example, the model is learned by inputting learning data including information (that is, the risk information and the countermeasure information) acquired by the effect calculation unit 204 as sample information and information of a calculation result output by the effect calculation unit 204 as information of a correct answer label. After this learning is performed, the risk information and the countermeasure information that are actually used are input to the model. The model outputs a calculation result relevant to the risk information and the countermeasure information. The effect calculation unit 204 outputs the output calculation result to the countermeasure selection unit 206. The countermeasure selection unit 206, the beneficiary identification unit 208, and the product design unit 210 may also execute processing of each unit similarly using the learned model.

The learned model may have a configuration including, for example, a neural network. Furthermore, such a model may be a model generated using a deep learning method and including layers such as a feature extraction layer and a fully connected layer.

However, each unit of the effect calculation unit 204, the countermeasure selection unit 206, the beneficiary identification unit 208, and the product design unit 210 may execute the above processing by using an arbitrary algorithm or the like instead of the learned model.

### [Description of Flow]

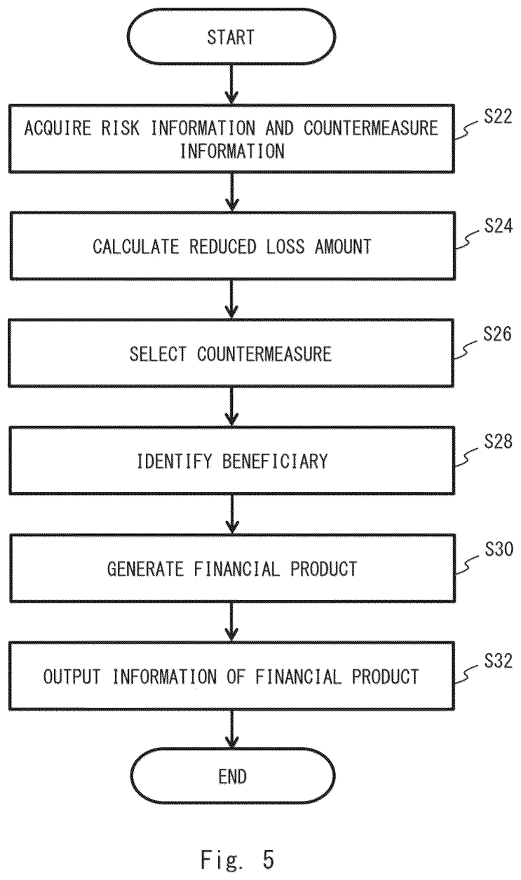

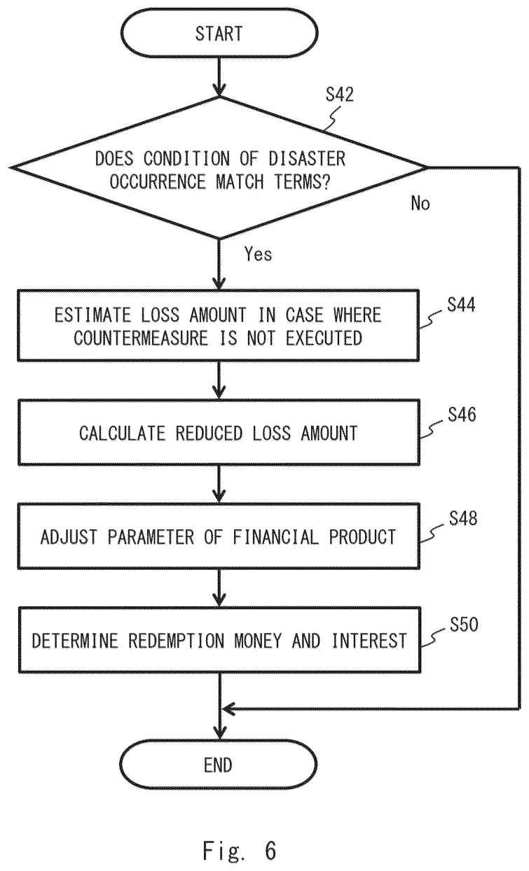

FIG. 5 is a flowchart illustrating an example of financial product generation processing of the product generation system 200, and FIG. 6 is a flowchart illustrating an example of payment determination processing of the product generation system 200. With these flowcharts, processing of the product generation system 200 will be described. Since details of each processing are as described above, description thereof is omitted as appropriate.

First, processing in the financial product generation stage will be described with reference to FIG. 5. The acquisition unit 202 acquires risk information of a disaster and countermeasure information in the target region (step S22). The effect calculation unit 204 uses the risk information and the countermeasure information to calculate, for each countermeasure, a loss amount that is considered to be reduced by the countermeasure (step S24). The countermeasure selection unit 206 selects one or more countermeasures for suppressing damage caused by a disaster based on the calculation result of the effect calculation unit 204 (step S26).

The beneficiary identification unit 208 identifies a beneficiary who receives a profit in a case where the target countermeasure is executed (step S28). The beneficiary identification unit 208 generates the identification information and the detailed information in step S28. The product design unit 210 generates a financial product based on the information on the target countermeasure, the identification information, and the detailed information (step S30). The output unit 212 outputs the information on the financial product generated in step S30 (step S32).

Next, processing in the payment determination stage will be described with reference to FIG. 6. In a case where a disaster occurs, the product design unit 210 compares the condition of the occurrence of the disaster with the contract terms of the financial product (step S42). In a case where the two do not match (No in step S42), the product generation system 200 does not perform any particular processing.

In a case where the two coincide with each other (Yes in step S42), the effect calculation unit 204 estimates the damage amount in a case where a disaster under the same condition occurs in a case where the target countermeasure is not executed (step S44). The effect calculation unit 204 calculates a decrease in the damage amount caused by execution of the target countermeasure from the estimated damage amount (step S46). The product design unit 210 adjusts the parameters of the financial product based on the amount of money calculated by the effect calculation unit 204 (step S48). The product design unit 210 determines redemption money and interest to be paid to the investor I based on the adjusted parameters (step S50).

### [Description of Effects]

In response to the increase in disaster risk with the progress of climate change, adaptive finance schemes have been studied to allocate funds to efforts to deal with this risk or to hedge the risk. By implementing this scheme, it is considered that it is possible to increase the possibility of long-term and stable return acquisition while suppressing the uncertainty generated in the business, the region, and the society.

As described above, to introduce disaster countermeasures into a target region, the product generation system 200 can provide services of a decrease (profit) in the damage amount caused by disaster countermeasures as a financial product. Therefore, the product generation system 200 can easily implement disaster countermeasures, and can suppress damage due to disaster and recover quickly, so that it is possible to provide profits to local residents and business operators. The product generation system 200 can also provide a profit in the form of a yield to an investor who has purchased a financial product.

The product generation system 200 may select one or more countermeasures based on a contract with the administrator. As a result, the product generation system 200 can select a countermeasure within the scope of the contract, and can cause the user to execute the countermeasure that is easy for the user to execute.

The product generation system 200 may calculate a profit (profit P or net profit Q) of the administrator for each countermeasure by using the risk information and the countermeasure information. As a result, the product generation system 200 can accurately calculate the profit. Therefore, the product generation system 200 can also generate a financial product in which appropriate parameters are set.

The product generation system 200 may calculate the profit by using at least one of a period subject to risk included in the risk information, an occurrence probability of a disaster, or a completion period. As a result, the product generation system 200 can calculate the profit more accurately. Therefore, the product generation system 200 can also generate a financial product in which more appropriate parameters are set.

The product generation system 200 may select one or more countermeasures based on the calculation result of the effect calculation unit 204 (for example, the profit of the administrator). As a result, the product generation system 200 can reliably select one that makes a profit as a countermeasure. Therefore, the product generation system 200 can also generate a product that is substantially valuable as a financial product.

The product generation system 200 may include a beneficiary identification unit 208 that identifies a beneficiary who receives profits in a case where the countermeasure is executed. Since the product generation system 200 generates a financial product based on the information on the identified beneficiary, it is possible to generate a product suitable for the beneficiary as a financial product.

### (2B)

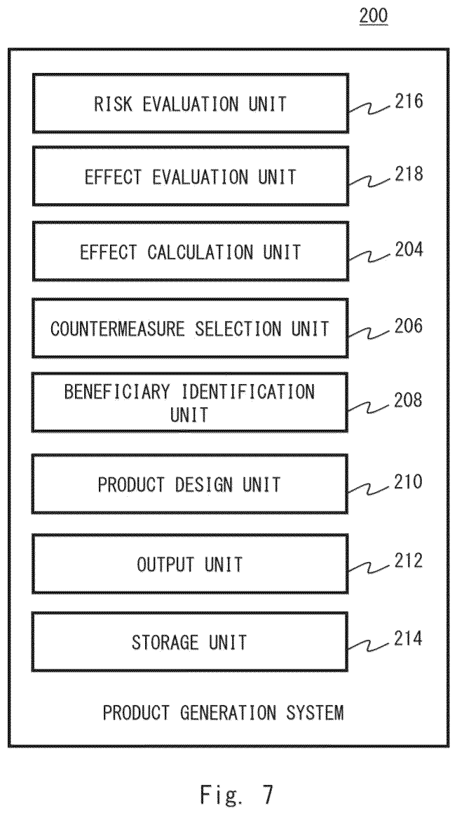

FIG. 7 is a block diagram illustrating an example of a product generation system according to the present disclosure. The product generation system 200 is different from FIG. 3 in that a risk evaluation unit 216 and an effect evaluation unit 218 are provided instead of the acquisition unit 202. Hereinafter, for the description of the product generation system 200, elements and processing common to those in (2A) will be omitted as appropriate, and description will be given focusing on differences from (2A).

The risk evaluation unit 216 generates risk information of a disaster related to a target region of a financial product. The risk information is indicated as, for example, a hazard map. The risk evaluation unit 216 generates risk information based on at least one of, for example, geographical information of a target region, weather prediction of the target region until a predetermined period in the future (for example, several years to several decades), or past risk information. For example, in a case where flood damage is assumed as a disaster, prediction of a precipitation amount in a predetermined period is used as weather prediction, and information of a position of a river in a target region and information of topography, geology, and buildings in a region around the river is used as geographical information. Using these pieces of information, the risk evaluation unit 216 predicts a risk of flooding of a river and flooding of a surrounding region in a predetermined period.

The effect evaluation unit 218 generates information on the details of the damage in a case where each of the plurality of countermeasures is executed based on the countermeasure against the disaster and the assumed scale of the disaster. As a result, the effect evaluation unit 218 generates countermeasure information including information on a countermeasure, an assumed disaster scale, and details of damage in a case where each countermeasure is executed. The effect evaluation unit 218 also includes information on the cost and the period required for completing each countermeasure in the countermeasure information.

Further description of the risk information and the countermeasure information generated as described above is as described in (2A) and thus is omitted. As described in (2A), the effect calculation unit 204 uses the generated risk information and countermeasure information to calculate, for each countermeasure, a loss amount that is considered to be reduced by the proposed countermeasure indicated in the countermeasure information. As described above, the risk information and the countermeasure information can be generated by the product generation system 200. However, either the risk evaluation unit 216 or the effect evaluation unit 218 may be provided in the product generation system 200.

### Third Example Embodiment

### (3A)

### [Description of Configuration]

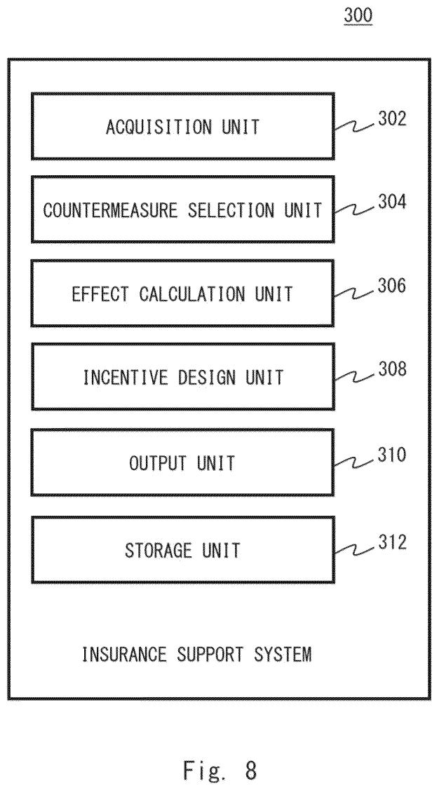

FIG. 8 is a block diagram illustrating an example of an insurance support system according to the present disclosure. An insurance support system 300 includes an acquisition unit 302, a countermeasure selection unit 304, an effect calculation unit 306, an incentive design unit 308, an output unit 310, and a storage unit 312. The insurance support system 300 is a system operated by, for example, a business operator (for example, an insurance company) that provides insurance relating to disasters. Hereinafter, a parametric insurance is assumed as an example of the insurance to be provided. However, the type of insurance that can be assumed is not limited thereto.

The acquisition unit 302 acquires risk information of a disaster related to a place where a management target to be covered by insurance exists, and information (hereinafter, also described as countermeasure information) related to a plurality of countermeasures for suppressing damage caused to the management target by the disaster. The risk information and the countermeasure information may be stored in the storage unit 312 or may be acquired by the acquisition unit 302 from the outside of the insurance support system 300. Alternatively, as shown in (3B), the insurance support system 300 may generate the risk information and the countermeasure information.

The risk information indicates a risk of disaster occurring in the target region from a short-term viewpoint. The risk information includes, for example, a period (for example, several seconds to one month) subject to a risk determination target of a disaster, an occurrence probability of a disaster within the period, a scale of an assumed disaster, and details of damage. Details of the damage are the same as those shown in (2A).

The countermeasure information includes a countermeasure action planned for suppressing damage caused by a disaster as a countermeasure. The countermeasure is a short-term countermeasure, and examples thereof include evacuation of vehicles, stacking of soil around buildings, and closing of water gates and roads as described above. As a short-term countermeasure, there are issuing an alarm for urging evacuation action, installing evacuation shelters, and the like. Here, it is assumed that there are a plurality of proposed countermeasures. The countermeasure information includes information regarding the scale of the assumed disaster and details of the damage in a case where each countermeasure is executed. The information regarding the details of the damage is as described above, and the loss is represented as, for example, a damage amount. Furthermore, the countermeasure information also includes information on the cost and period required for completing each proposed countermeasure. The detailed description of the other risk information and countermeasure information is similar to that described in the second example embodiment.

The countermeasure selection unit 304 selects or generates one or more countermeasures (actions) to be taken by the management target or the owner who owns the management target based on the risk information and the countermeasure information. The owner is, for example, an insurance contractor related to a management target.

For example, the countermeasure selection unit 304 compares the period subject to a risk determination target with the completion period of the countermeasure. Then, the countermeasure selection unit 304 selects a countermeasure such that the completion period of the countermeasure is shorter than the period subject to a risk determination target. The countermeasure selection unit 304 may select a countermeasure such that the completion period of the countermeasure is shorter than the period subject to a risk determination target by a predetermined time or more.

As an example, it is assumed that the management target is a vehicle, and there is a possibility that a tsunami will arrive at a place where the vehicle is located within 20 minutes as the risk information. Here, the risk information is a hazard map indicating information on geography and buildings near the vehicle. It is assumed that a countermeasure against flood damage included in the countermeasure information includes evacuation to an evacuation place having a predetermined height or more. Here, the evacuation place is defined in the countermeasure information as a building having a high ground or a parking lot.

At this time, the countermeasure selection unit 304 refers to the hazard map and specifies a high ground closest to the place where the vehicle is and a building having a predetermined height or more closest to the place where the vehicle is. In this example, the countermeasure selection unit 304 specifies a commercial facility as a building having a predetermined height or more. Thereafter, the countermeasure selection unit 304 measures the distance between the place of the vehicle and the specified high ground and the distance between the place of the vehicle and the specified commercial facility. The countermeasure selection unit 304 calculates the time until the vehicle arrives at each evacuation place by dividing each distance by the moving speed of the vehicle (for example, the speed stored in the storage unit 312).

For example, the countermeasure selection unit 304 calculates that it takes 25 minutes for the vehicle to reach a high ground and 15 minutes for the vehicle to reach a commercial facility. Based on the calculation result, the countermeasure selection unit 304 specifies whether the vehicle can arrive at each place within the time limit (that is, within 20 minutes). In this case, the vehicle can arrive at the commercial facility within 20 minutes. Therefore, the countermeasure selection unit 304 selects evacuation to the specified commercial facility as an action to be taken by the owner of the vehicle. The countermeasure selection unit 304 may specify a place where the vehicle can escape with a margin by setting the time limit until the vehicle arrives to less than 20 minutes instead of 20 minutes. Calculation can be similarly performed in a case where the management target is not a vehicle but a person or the like.

The countermeasure selection unit 304 may generate a countermeasure based on the countermeasure information. For example, it is assumed that the countermeasure information indicates a countermeasure for evacuating to an evacuation place having a predetermined height or more, but what kind of place the evacuation place is is not specified. At this time, the countermeasure selection unit 304 refers to the information of the hazard map around the place where the vehicle is located as a specific example of the evacuation place. As a result, the countermeasure selection unit 304 specifies a building having a hill or a parking lot as an evacuation place having a predetermined height or higher in the vicinity of the place where the vehicle is located. Then, the countermeasure selection unit 304 generates a countermeasure against flood damage included in the countermeasure information as evacuating to a high ground having a predetermined height or more or a building having a parking lot.

The countermeasure selection unit 304 may calculate the time until the vehicle arrives at each evacuation place in consideration of not only the distance between the vehicle and the evacuation place but also the road condition between the vehicle and the evacuation place in a case where evacuating the vehicle. For example, the countermeasure selection unit 304 refers to the hazard map and specifies a commercial facility A and a commercial facility B as buildings having a predetermined height or more within a predetermined distance from a place where the vehicle is. Thereafter, the countermeasure selection unit 304 measures the distance between the place where the vehicle is located and the commercial facility A and the distance between the place where the vehicle is located and the commercial facility B. The countermeasure selection unit 304 further grasps the road condition between the place where the vehicle is located and the commercial facility A and the road condition between the place where the vehicle is located and the commercial facility B. The countermeasure selection unit 304 calculates that the vehicle arrives at the commercial facility A in 23 minutes and the vehicle arrives at the commercial facility B in 17 minutes based on the measured distance and the road condition. Based on the calculation result, the countermeasure selection unit 304 selects evacuation to the specified commercial facility B as an action to be taken by the owner of the vehicle. The information on the road condition can be acquired by the acquisition unit 302 via the Internet or the like, for example.

The countermeasure selection unit 304 may use the risk information and the countermeasure information to calculate, for each countermeasure, a loss amount that is considered to be reduced by the countermeasure. The risk information includes information on the loss A, and the countermeasure information includes information on the loss B and the burden C. The countermeasure selection unit 304 calculates the profit P or the net profit Q as a loss amount that is considered to be decreased by the countermeasure. The countermeasure selection unit 304 may select, from among the plurality of countermeasures, at least one of the countermeasure that maximizes the profit P or the net profit Q or the countermeasure that minimizes the burden C.

As an example, it is assumed that the management target is a vehicle, and there is a possibility that a flood may occur in a place where the vehicle is located after two days as the risk information. Details of the risk information are as described above. It is assumed that two countermeasures for flood damage included in the countermeasure information and having the same effect of risk avoidance include evacuation to a high ground having a predetermined height or more and evacuation to a building having a predetermined height or more. For example, the countermeasure selection unit 304 determines that the fuel cost required for evacuation to a high ground is lower than the fuel cost required for evacuation to a building having a predetermined height or more. At this time, the countermeasure selection unit 304 selects evacuation to a high ground as an action to be taken by the owner of the vehicle. Alternatively, in a case where the fuel cost for evacuation to a high ground is equal to or less than a predetermined amount of money, the countermeasure selection unit 304 may select evacuation to a high ground as an action to be taken by the vehicle owner.

The countermeasure selection unit 304 may select one countermeasure from a plurality of countermeasures. Here, only one of the plurality of countermeasures can be executed based on a physical or budget constraint condition. The countermeasure selection unit 304 may select one countermeasure based on at least one of the profit P, the net profit Q, the burden C, or the completion period in each countermeasure. For example, the countermeasure selection unit 304 may select any one of the profit P, the net profit Q, the value obtained by dividing the profit P or the net profit Q by the burden C being the maximum, the burden C, and the completion period being the minimum. Alternatively, the countermeasure selection unit 304 may set a function using two or more parameters of the profit P, the net profit Q, the burden C, and the completion period, and select a countermeasure having the maximum or minimum value calculated using the function for each countermeasure. The countermeasure selection unit 304 may select a countermeasure without using at least one of the profit P, the net profit Q, or the burden C in each countermeasure in a case where the period subject to a risk determination target is less than the predetermined period.

However, the countermeasure selection unit 304 may include a plurality of countermeasures that can be executed in parallel in the countermeasure. Here, the countermeasure selection unit 304 may impose a constraint condition such that at least one of a total burden amount obtained by summing the burden C of a plurality of countermeasures or a period during which all of the plurality of countermeasures are completed is equal to or less than a predetermined value. Instead of this constraint condition or in addition to this constraint condition, the countermeasure selection unit 304 may impose a constraint condition such that a total profit amount obtained by adding the profits P (or the net profit Q) of a plurality of countermeasures is equal to or more than a predetermined value. Furthermore, the countermeasure selection unit 304 may select one or more countermeasures based on contract information between the administrator and the insurance company.

The countermeasure selection unit 304 outputs information on the countermeasure (hereinafter, also referred to as a determined countermeasure) that has been determined as described above to the effect calculation unit 306.

The effect calculation unit 306 calculates the profit P (or the net profit Q) based on the information on the management target and the information on the determined countermeasure. Here, the loss A is a payment amount of insurance money set as a management target in a case where a disaster occurs in a state where the determined countermeasure is not executed. The loss B is a payment amount of insurance money set as a management target in a case where a disaster occurs in a state where the determined countermeasure is executed. That is, the effect calculation unit 306 analyzes the effect of the determined countermeasure. The payment amount of the insurance money may be data stored in advance in the storage unit 312, or may be calculated based on the risk information as shown in (2B). As a result of the calculation, in a case where the profit P is equal to or more than the predetermined amount of money, the incentive design unit 308 outputs information on the determined countermeasure.

The incentive design unit 308 sets an incentive to be paid in a case where evacuation is performed for a person (an insurance contractor, for example, an owner to be managed) who evacuates a management target based on the information of the determined countermeasure. The incentive is expressed in the form of, for example, a reward. The incentive design unit 308 sets the incentive to be an amount of money less than the profit P or the net profit Q. The net profit Q is an amount obtained by subtracting the burden C, which is a cost required in a case where the determined countermeasure is executed, from the profit P. The incentive design unit 308 may set the incentive to have a value larger than the burden C.

The incentive design unit 308 may set an incentive based on at least one of insurance contract information related to a management target, an occurrence probability of a disaster, a scale of a disaster, a period subject to a risk determination target of the disaster, a completion period of a countermeasure, a profit P, a net profit Q, or a burden C. The insurance contract information includes a payment amount per time unit (month, year, etc.) of the insurance in addition to the conditions under which the insurance is applied. For example, the incentive design unit 308 may increase the incentive in a case where at least one of the payment amount per time unit of the insurance, the occurrence probability of a disaster, the scale of a disaster, the completion period of the countermeasure, or the profit P or the net profit Q increases. The incentive design unit 308 may increase the incentive in a case where at least one of the period subject to the risk determination target or the burden C is reduced.

The output unit 310 outputs the information on the determined countermeasure and the derived information on the incentive to the terminal of the owner (or the person himself/herself in a case where the management target is a person) to be managed. The owner of the object to be managed who is the insurance contractor has a risk that the object to be managed is damaged by the disaster, and thus can be said to be a potential disaster victim. The owner refers to the notification from the output unit 310, and executes an action to evacuate the management target from the disaster based on the information of the determined countermeasure.

In a case where a plurality of determined countermeasures is determined, the output unit 310 may output the plurality of determined countermeasures to the terminal. At this time, the owner determines which one of the plurality of determined countermeasures output to the terminal is to be executed. In a case where a plurality of determined countermeasures are executed, the total amount of the incentive set for each determined countermeasure is paid to the owner.

In a case where the acquisition unit 302 acquires information (hereinafter, also described as execution confirmation information) indicating that the determined countermeasure has been executed, the incentive design unit 308 sets the incentive set for the determined countermeasure to the temporarily established state. Thereafter, the incentive design unit 308 sets the set incentive to the established state in a case where the acquisition unit 302 acquires information indicating that the damage to be managed has been suppressed by the execution of the determined countermeasure or information indicating that the determined countermeasure has been executed at the time of disaster (hereinafter, described as damage suppression information and execution end information). The damage suppression information is, for example, information indicating that the damage is 0. The state in which the incentive is in the temporarily established state and the state in which the incentive is established are output from the output unit 310 to the owner's terminal. The incentive is paid by the insurance company to the insurance contractor.

For example, the acquisition unit 302 may acquire the execution confirmation information, the damage suppression information, or the execution end information as a result of monitoring executed by the insurance company. Alternatively, the owner may photograph an image showing the management target, and the image may be transmitted to the insurance support system 300, whereby the acquisition unit 302 may acquire these pieces of information.

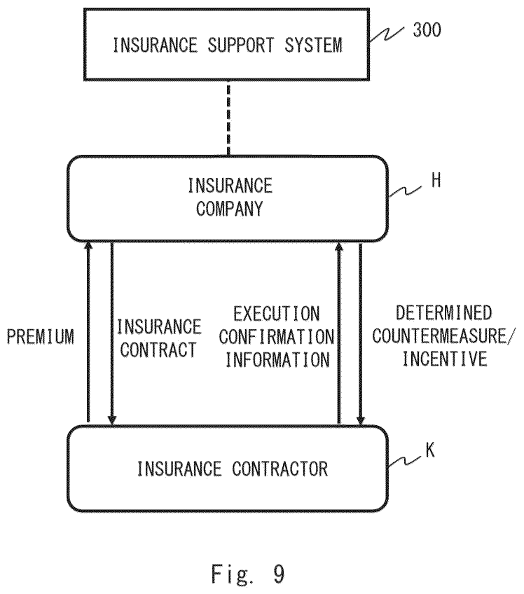

FIG. 9 is a diagram illustrating a relationship between parties in insurance. An insurance company H that provides insurance makes an insurance contract with an insurance contractor K and receives an insurance premium from the insurance contractor K. Then, in a case where a disaster is predicted to occur, a determined countermeasure is output from the insurance support system 300 to the terminal of the insurance contractor K. The insurance contractor K executes an action to evacuate the management target accordingly. Thereafter, the terminal of the insurance contractor K outputs the execution confirmation information and the like to the insurance support system 300 as described above. Then, the insurance company H pays an incentive to the insurance contractor K.

For at least one of the countermeasure selection unit 304, the effect calculation unit 306, or the incentive design unit 308, for example, the above-described processing may be executed using a learned model stored in the storage unit 312. The model is a model learned by a machine learning method. For example, the model is learned by inputting learning data including information (that is, the risk information and the countermeasure information) acquired by the countermeasure selection unit 304 as sample information and information (that is, the countermeasure) output by the countermeasure selection unit 304 as information of a correct answer label. After this learning is performed, the risk information and the countermeasure information that are actually used are input to the model. The model outputs the risk information and the countermeasure relevant to the countermeasure information. The countermeasure selection unit 304 outputs the output calculation result to the effect calculation unit 306. For the effect calculation unit 306 and the incentive design unit 308, processing of each unit may be executed similarly using the learned model.

The learned model may have a configuration including, for example, a neural network. Furthermore, such a model may be a model generated using a deep learning method and including layers such as a feature extraction layer and a fully connected layer.

However, each unit of the countermeasure selection unit 304, the effect calculation unit 306, and the incentive design unit 308 may execute the above processing by using an arbitrary algorithm or the like instead of the learned model.

### [Description of Flow]

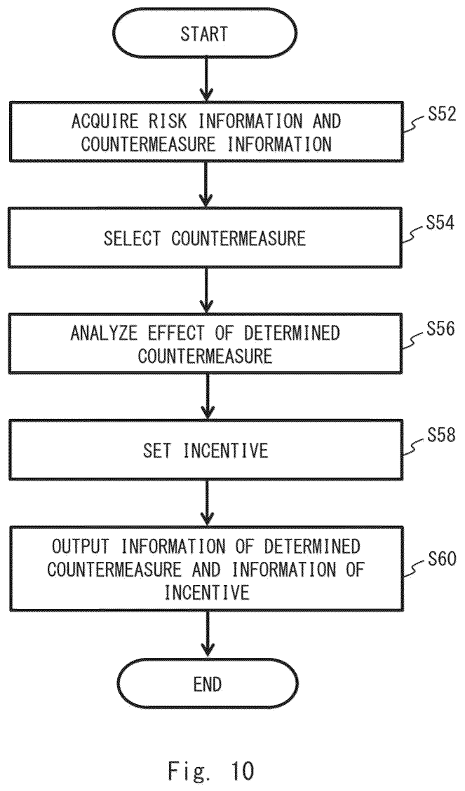

FIG. 10 is a flowchart illustrating an example of countermeasure determination processing of the insurance support system 300. With this flowchart, processing of the insurance support system 300 will be described. Since details of each processing are as described above, description thereof is omitted as appropriate.

First, the acquisition unit 302 acquires risk information of a disaster and countermeasure information (step S52). The countermeasure selection unit 304 selects one or more countermeasures to be taken by the owner who owns the management target based on the risk information and the countermeasure information (step S54). The effect calculation unit 306 analyzes the effect of the determined countermeasure based on the information to be managed and the information on the determined countermeasure (step S56). The incentive design unit 308 sets an incentive to be paid in a case where evacuation is performed for the insurance contractor based on the information of the determined countermeasure (step S58). The output unit 310 outputs the information on the determined countermeasure and the derived information on the incentive to the terminal (step S60).

### [Description of Effects]

As described above, in a case where there is a high possibility that a disaster will occur in the near future, the insurance support system 300 can notify the administrator (or the insurance contractor) to evacuate the object to be managed which is an insurance object. Therefore, the administrator can avoid disaster by evacuating the management target.

The insurance support system 300 may include an incentive design unit 308 that sets an incentive for executing the countermeasure. As a result, it is possible to increase the possibility of evacuation by giving motivation for evacuation to a person who evacuates the management target. The insurance company only needs to pay an incentive which is an amount much lower than the insurance money as the expenditure at the time of disaster occurrence. Therefore, the expenditure of the insurance company can be reduced.

The incentive design unit 308 may set an incentive based on at least one of insurance contract information related to a management target, an occurrence probability of a disaster, a scale of a disaster, a period subject to a risk determination target of the disaster, a completion period of a countermeasure, or the like. As a result, the insurance support system 300 can set an appropriate incentive according to the situation.

However, the incentive design unit 308 is not essential in the insurance support system 300. In this case, the output unit 310 outputs the information on the determined countermeasure to the administrator terminal. For example, in a case where the administrator is a local government and the management target is a predetermined region, the output unit 310 outputs information on the determined countermeasure to the terminal of the local government. In response to the information, the local government executes countermeasures such as issuing an alarm for urging evacuation action, installing evacuation shelters, and closing water gates and roads. In this way, the insurance support system 300 can motivate the local government to execute the countermeasure at an early stage, so that it is possible to suppress damage due to disaster.

### (3B)

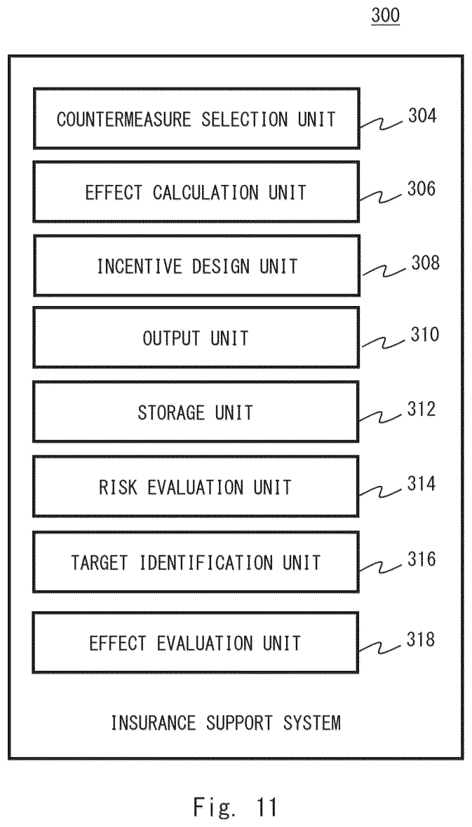

FIG. 11 is a block diagram illustrating an example of an insurance support system according to the present disclosure. The insurance support system 300 is different from that of FIG. 8 in including a risk evaluation unit 314, a target identification unit 316, and an effect evaluation unit 318 instead of the acquisition unit 302. Hereinafter, for the description of the insurance support system 300, elements and processing common to those in (3A) will be omitted as appropriate, and description will be given focusing on differences from (3A).

The risk evaluation unit 314 generates risk information of a disaster related to a region where a management target is present. The risk information is indicated as, for example, a hazard map. The risk evaluation unit 314 generates risk information based on at least one of, for example, geographical information of a region, weather prediction of a region until a predetermined period in the near future (for example, several seconds to one month), or past risk information. Details thereof are as described in (2B).

The target identification unit 316 uses the information of the list of insurance contractors stored in the storage unit 312 to identify an insurance contractor in a region determined to have risk of a disaster according to the risk information. For example, the target identification unit 316 identifies an insurance contractor in a region where it is determined that the risk of disaster is equal to or greater than a predetermined value in the risk information. Specifically, the target identification unit 316 compares the information of the address or residence in the list of insurance contractors with the region determined to have the risk of disaster, and identifies the matched insurance contractor in a case where the two match. At that time, the target identification unit 316 also identifies the management target stored in the storage unit 312 in association with the insurance contractor. As described above, the target identification unit 316 identifies potential disaster victims.

After identifying the insurance contractor and the management target, the target identification unit 316 calculates a loss expectation value generated for the management target due to the disaster based on the risk information. For example, in a case where the management target is a house and the disaster is a typhoon, the target identification unit 316 estimates the loss expectation value to be higher as the force of the typhoon becomes stronger. Then, the target identification unit 316 refers to the loss expectation value and the insurance contract information to calculate the payment amount of the insurance money set as the management target at the time of occurrence of the disaster in a case where no countermeasure is taken. The payment amount of the insurance money is included in the risk information as the loss A.

The effect evaluation unit 318 generates information on the details of the damage in a case where each of the plurality of countermeasures is executed based on the countermeasure against the disaster and the assumed scale of the disaster. As a result, the effect evaluation unit 318 generates countermeasure information including information on a countermeasure, an assumed disaster scale, and details of damage in a case where each countermeasure is executed. The effect evaluation unit 318 also includes information on the cost and the period required for completing each countermeasure in the countermeasure information.

As described in (3A), the effect calculation unit 306 uses the generated risk information and countermeasure information to calculate, for each countermeasure, a loss amount that is considered to be reduced by the proposed countermeasure indicated in the countermeasure information. As described above, the insurance support system 300 can generate risk information and countermeasure information. However, at least one of the risk evaluation unit 314, the target identification unit 316, or the effect evaluation unit 318 may be provided in the insurance support system 300.

The output unit 310 can output the information of the determined countermeasure and the derived information of the incentive to the terminal of the insurance contractor identified by the target identification unit 316. Therefore, output of information to a person other than the insurance contractor is suppressed, and unnecessary processing can be suppressed.

### (3C)

The risk information acquired by the acquisition unit 302 in (3A) or the risk information generated by the risk evaluation unit 314 in (3B) may be updated as appropriate. Each unit of the insurance support system 300 can execute the above processing using the updated risk information. As a result, the determined countermeasure determined by the countermeasure selection unit 304 and the incentive set by the incentive design unit 308 may also be updated.

For example, the insurance support system 300 may further acquire disaster information of a region related to a place where the management target exists. The disaster information is, for example, disaster information (hereinafter, also referred to as neighboring disaster information) of a region adjacent to a place where the management target exists or a region within a predetermined distance from the place where the management target exists. The neighboring disaster information includes information indicating details of a scale and damage of a disaster occurring in a neighboring region. The acquisition unit 302 in (3A) may acquire the neighboring disaster information as the risk information, or the risk evaluation unit 314 in (3B) may generate the risk information using the neighboring disaster information. In this manner, the risk information is updated in accordance with the contents of the neighboring disaster information.

For example, in a case where the administrator is a local government and the management target is a predetermined region, the countermeasure selection unit 304 updates the determined countermeasure based on the updated risk information. Examples of updating of the determined countermeasure executed by the countermeasure selection unit 304 include at least one of changing (for example, increasing) a level of an alarm for urging evacuation action, changing (for example, expanding a region) a region for which an alarm for urging evacuation action is issued, or changing (for example, increasing the number of openings) the number of evacuation shelters.

The incentive design unit 308 may change the previously set incentive based on the update of the determined countermeasure. For example, the incentive design unit 308 may increase the set incentive more than the previously-set incentive after satisfying a condition that the incentive is an amount of money less than the profit P or the net profit Q. As a result, it is possible to further increase the possibility of evacuation by further giving motivation for evacuation to a person who evacuates the management target.

The output unit 310 outputs the information on the determined countermeasure and the incentive information updated as described above to the terminal of the owner (or, a person himself/herself in a case where the management target is a person) to be managed.

As described above, the insurance support system 300 can notify the administrator to raise the warning about the disaster according to the neighboring disaster information. As a result, the effect of suppressing damage to a disaster can be further enhanced.

Similarly to the information processing system 100, the systems described in the second to third example embodiments may be configured as a single computer device, or may be configured as a distributed system including a plurality of computer devices.

In the example embodiments described above, the present disclosure has been described as a hardware configuration, but the present disclosure is not limited thereto. In the present disclosure, the processing of the apparatus configuring the information processing system 100, the product generation system 200, or the insurance support system 300 described in the above example embodiments can also be implemented by causing a processor in a computer to execute a computer program.

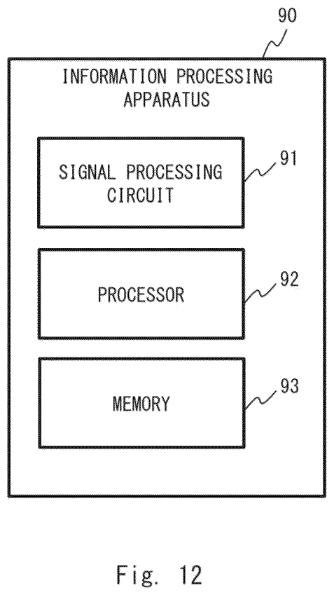

FIG. 12 is a block diagram illustrating a hardware configuration example of an information processing apparatus (i.e., computer) in which processing of the system or apparatus illustrated in each example embodiment is executed. Referring to FIG. 12, an information processing apparatus 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected to the memory 93, and reads and executes a computer program from the memory 93 to execute the processing in the system described in the above example embodiments. As an example of the processor 92, one of a central processing unit (CPU), a micro processing unit (MPU), a field-programmable gate array (FPGA), a digital signal processor (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a read-only memory (ROM) such as a programmable read-only memory (PROM) or an erasable programmable read-only memory (EPROM), a flash memory, or a solid-state drive (SSD).

The memory 93 is used to store one or more instructions. Here, one or more instructions are stored in the memory 93 as a program. The processor 92 can execute the processing described in the above example embodiments by reading and executing these programs from the memory 93.

Note that the memory 93 may include a memory built in the processor 92 in addition to a memory provided outside the processor 92. The memory 93 may include a storage disposed away from a processor implementing the processor 92. In this case, the processor 92 can access the memory 93 via an input/output (I/O) interface.

As described above, one or more processors included in each apparatus or system of the above example embodiments execute one or more programs including a group of instructions for causing a computer to execute an algorithm described with reference to the drawings. By executing the program, the information processing described in each example embodiment can be implemented.

The program described above includes a group of commands or software codes for causing a computer to perform one or more functions described in the example embodiments if the program is read by the computer. The program may be stored in a non-transitory computer-readable medium or a tangible storage medium. As an example and not by way of limitation, a computer-readable medium or tangible storage medium includes a random access memory (RAM), a read-only memory (ROM), a flash memory, a solid-state drive (SSD) or other memory technology, a compact disc read-only memory (CD-ROM), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals. The transitory computer-readable media or communication media can supply the programs to the computer via a wired communication path such as an electric wire and an optical fiber or a wireless communication path.

Some or all of the above-described example embodiments may be described as the following supplementary notes, but are not limited to the following supplementary notes.

### (Supplementary Note 1)

An information processing system including:
an acquisition means for acquiring risk information of a disaster related to a place where a management target managed by an administrator is present;
a selection means for selecting one or more countermeasures for suppressing damage caused by the disaster based on the risk information;
a calculation means for calculating a profit of the administrator which is generated in a case where at least one of the one or more countermeasures is executed; and
an output means for outputting the one or more countermeasures and the profit.

### (Supplementary Note 2)

The information processing system according to Supplementary Note 1, in which the calculation means calculates a profit of the administrator based on the one or more countermeasures and the risk information.

### (Supplementary Note 3)

The information processing system according to Supplementary Note 2, in which the calculation means calculates a profit of the administrator by using at least one of a period subject to risk included in the risk information, an occurrence probability of the disaster, or a period required for completing the one or more countermeasures.

### (Supplementary Note 4)

The information processing system according to any one of Supplementary Notes 1 to 3, further including an incentive setting means for setting an incentive for executing the one or more countermeasures based on information on the one or more countermeasures.

### (Supplementary Note 5)

The information processing system according to Supplementary Note 4, in which the incentive setting means sets the incentive by further using at least one of insurance contract information related to the management target, an occurrence probability of the disaster, a scale of the disaster, a period subject to a risk determination target of the disaster, or a period required for completing the one or more countermeasures.

### (Supplementary Note 6)

The information processing system according to any one of Supplementary Notes 1 to 5, in which the selection means selects the one or more countermeasures based on a profit of the administrator.

### (Supplementary Note 7)

The information processing system according to any one of Supplementary Notes 1 to 6, further including a generation means for generating a financial product based on the one or more countermeasures and the profit.

### (Supplementary Note 8)

The information processing system according to Supplementary Note 7, further including a beneficiary identification means for identifying a beneficiary who receives a profit in a case where the one or more countermeasures are executed,
in which the generation means generates a financial product based on the one or more countermeasures, the profit, and information on the beneficiary.

### (Supplementary Note 9)

The information processing system according to any one of Supplementary Notes 1 to 8, in which the selection means selects the one or more countermeasures from a plurality of countermeasures based on a contract with the administrator.

### (Supplementary Note 10)

The information processing system according to any one of Supplementary Notes 1 to 9, in which
the calculation means calculates a cost of the administrator which is generated in a case where the one or more selected countermeasures are executed, and
the output means further outputs a value obtained by adding the cost to the profit.

### (Supplementary Note 11)

The information processing system according to any one of Supplementary Notes 1 to 10, in which the administrator is a local government, and the management target is a region managed by the local government.

### (Supplementary Note 12)

The information processing system according to any one of Supplementary Notes 1 to 11, in which
the calculation means calculates a disadvantage to the administrator which is generated in a case where the selected one or more countermeasures are not executed, and
the output means further outputs the disadvantage.

### (Supplementary Note 13)

An information processing method executed by a computer, including:
acquiring, by an acquisition means, risk information of a disaster related to a place where a management target managed by an administrator is present;
selecting, by a selection means, one or more countermeasures for suppressing damage caused by the disaster based on the risk information;
calculating, by a calculation means, a profit of the administrator which is generated in a case where at least one of the one or more countermeasures is executed; and
outputting, by an output means, the one or more countermeasures and the profit.

### (Supplementary Note 14)

A program for causing a computer to function as:
an acquisition means for acquiring risk information of a disaster related to a place where a management target managed by an administrator is present;
a selection means for selecting one or more countermeasures for suppressing damage caused by the disaster based on the risk information;
a calculation means for calculating a profit of the administrator which is generated in a case where at least one of the one or more countermeasures is executed; and
an output means for outputting the one or more countermeasures and the profit.

Some or all of the elements (e.g., configurations and functions) described in Supplementary Notes 2 to 12 depending from Supplementary Note 1 may depend from Supplementary Notes 13 to 14 as well with depending relationships similar to those of Supplementary Notes 2 to 12. Some or all of the elements described in any Supplementary Note may be applied to various types of hardware, software, recording means for recording software, systems, and methods.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

What is claimed is:

1. An information processing system comprising:
one or more memories that store instructions; and
one or more processors that execute the instructions,
wherein the one or more processors execute the instructions to perform:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.

2. The information processing system according to claim 1, wherein the one or more processors execute the instruction to perform calculating a profit of the administrator based on the one or more countermeasures and the risk information.

3. The information processing system according to claim 2, wherein the one or more processors execute the instruction to perform calculating a profit of the administrator by using at least one of a period subject to risk included in the risk information, an occurrence probability of the disaster, or a period required for completing the one or more countermeasures.

4. The information processing system according to claim 1, wherein the one or more processors execute the instruction to perform setting an incentive for executing the one or more countermeasures based on information on the one or more countermeasures.

5. The information processing system according to claim 4, wherein the one or more processors execute the instruction to perform setting the incentive by further using at least one of insurance contract information related to the management target, an occurrence probability of the disaster, a scale of the disaster, a period subject to a risk determination target of the disaster, or a period required for completing the one or more countermeasures.

6. The information processing system according to claim 1, wherein the one or more processors execute the instruction to perform selecting the one or more countermeasures based on a profit of the administrator.

7. The information processing system according to claim 1, wherein the one or more processors execute the instruction to perform generating a financial product based on the one or more countermeasures and the profit.

8. The information processing system according to claim 7, wherein the one or more processors execute the instruction to perform:
identifying a beneficiary who receives a profit in a case where the one or more countermeasures are executed; and
generating a financial product based on the one or more countermeasures, the profit, and information on the beneficiary.

9. The information processing system according to claim 1, wherein the one or more processors execute the instruction to perform selecting the one or more countermeasures from a plurality of countermeasures based on a contract with the administrator.

10. The information processing system according to claim 1, wherein the one or more processors execute the instruction to perform:
calculating a cost of the administrator which is generated in a case where the one or more selected countermeasures are executed; and
further outputting a value obtained by adding the cost to the profit.

11. The information processing system according to claim 1, wherein the administrator is a local government, and the management target is a region managed by the local government.

12. The information processing system according to claim 1, wherein the one or more processors execute the instruction to perform:
calculating a disadvantage to the administrator which is generated in a case where the selected one or more countermeasures are not executed; and
further outputting the disadvantage.

13. The information processing system according to claim 1, wherein the one or more processors execute the instruction to perform:
sending, to a terminal of a user, information for prompting the user to execute the countermeasures based on information of the countermeasures.

14. An information processing method executed by a computer, comprising:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.

15. A non-transitory computer-readable medium storing a program for causing a computer to execute:
acquiring risk information of a disaster related to a place where a management target managed by an administrator is present;
selecting one or more countermeasures for suppressing damage caused by the disaster based on the risk information;
calculating a profit of the administrator which is generated in a case where at least one of the one or more countermeasures is executed; and
outputting the one or more countermeasures and the profit.
